(19) United States
(12) Patent Application Publication
(10) Pub. No.: US 2012/0166557 A1
(43) Pub. Date: Jun. 28, 2012

(54) INFORMATION SEARCH METHOD USING ELECTRONIC MAIL ADDRESS

(76) Inventor: Toshio Hayakawa, Los Angeles, CA (US)

(21) Appl. No.: 13/328,629

(22) Filed: Dec. 16, 2011

Related U.S. Application Data
(60) Provisional application No. 61/427,478, filed on Dec. 28, 2010.

(51) Int. Cl. G06F 15/16

(52) U.S. Cl. 709/206; 707/E17.014

(57) ABSTRACT

A user can search information about products or services, its description, its price or price range and any other information by sending electronic mails or short message service, where user identifiers are replaced with search words that each search word is connected by underscore character or other distinctive character to data servers.

### CROSS REFERENCE TO RELATED APPLICATIONS

This application claims the benefit of Provisional Patent Application Ser. No. 61/427,478, filed 2010 Dec. 28 by the present inventor.

### BACKGROUND—PRIOR ART

Most information search methods require having communication devices such as personal computers (PC) or new type of cell phones called smart phones that have the capability to make Internet connection. PC or smart phone users can search products and services using search engines such as Google, Yahoo, Bing, etc., and browsers such as Internet Explorer, developed by Microsoft Corp., or Firefox, developed by Mozilla Corp. etc. on the Internet.

However, it is not easy to find items and services which prices change daily or weekly using above conventional search methods, because it is costly to update its information frequently. Hence, many stores owners are reluctant to do so. Also, such engines generally do not provide a list of the lowest priced items for the same brands in any given area. Another issue is that many large grocery stores have very large number of sales items, and listing large numbers of such items on the Internet is not practical. Furthermore, it is difficult to view these prices using smart phones because the screen size is too small to view any large number of sales items.

This invention provides a more precise search method than the conventional search methods described above to look for information on any large number of store items and services which prices change daily or weekly. It also provides a list of the lowest priced items for the same brands in any given area without use of global positioning system (GPS). Furthermore, this search method can find products and service information without using the Internet and GPS since e-mail software can run on any electronic communication devices.

FIGS. 59C-E and 88-90 in U.S. Pat. No. 7,809,709 (“the '709 patent”) purport to show Internet searches transmitted by e-mail to a search engine. According to the claims of the '709 patent results can also be transmitted in emails. The method used in these figures in the '709 patent appears to be different than that used in this invention, specifically, the user address is not modified as part of submitting the search query. None of other patents listed below appear to disclose this newly invented method of replacing the user identifier with information used for searching information as described above.

| Patent Number | Name | Date |
|---|---|---|
| US Application 20100228772 | Manno | Sep. 9, 2010 |
| US Application 20090299727 | Fux et al. | Dec. 3, 2009 |
| U.S. Pat. No. 7,809,709 | Harrison | Oct. 5, 2010 |
| U.S. Pat. No. 7,599,938 | Harrison | Oct. 6, 2009 |
| U.S. Pat. No. 7,299,032 | Yamada et al. | Nov. 20, 2007 |

### SUMMARY

With an introduction of a new cell phone type called smart phone, many applications (apps) that run on these smart phones can search the same information as PC users can. For example, there is an app developed for finding the lowest gas price within an area. However, to search for another item information by the same app, another new app must be written since the information of the gas price has several price informations such as unleaded, medium grade, premium and diesel, which is different from a single item having only one price structure.

This newly invented search engine technology can search any information and can make communication between an e-mail software and data servers without the use of Internet since e-mail does not require having an Internet connection. Hence, it works for not only smart phones but also for any cell phones or any other devices that are capable of receiving and sending e-mails.

### DETAIL DESCRIPTION

Typical e-mail addresses, such as “john_smith@gdm2.com”, have two parts. The part before the “@” sign is the local-part of the address, often the username of the recipient (john_smith), and the part after the “@” sign (gdm2.com) is the domain name to which an e-mail message will be sent. Using this e-mail format, electronic mails and messages are sent to the recipient from any device that is capable of sending and receiving e-mails, of which these devices are connected to mail servers.

At least, this invention has two functions in an e-mail app. One is setting search criteria function and the other is communication function. Instead of using e-mail as means of sending and receiving messages, this invention uses the local part of the addresses of the e-mail apps to set search criterias for the purpose of searching information and the domain part is the communication part as means of communicating between the e-mail app, and mail servers.

Typically, a user types search words separated by white spaces in the Google search bar. The same method is used to search information using this newly invented search engine technology, except an underscore character is appended by the e-mail app for each word instead of a white space. For example, if the user wants to search bread information in an_area specified by the ZIP code 90034, the user types “bread” and “90034” randomly into the input screen of the e-mail app. Then it composes a new search e-mail address, which is the following: bread_{—}90034_@gdm2.com.

If the user wants to specify the price or price range, the user types “$1” and “$5” to set the lowest and highest price respectively. When the user clicks a send button on the e-mail app, it composes the entire send e-mail address, which is the following: bread_{—}90034_$1_$2_@gdm2.com. Then the e-mail is received at the domain name. In this case, gdm2.com is the domain name, where the mail servers and the data servers are configured.

Since the user types search words randomly and the new search e-mail address is created by the e-mail app, it may not exist in an e-mail server. To treat it as the unregistered search e-mail address and to avoid sending it back to the sender, the e-mail server creates it. Then, the e-mail server separates the local part of the search e-mail address into each word and sends them to data servers where data search operation is processed and searched results are sent to the user. The data servers contain information such as product names, descriptions, price or price range, names and addresses of stores, and other related information about the products.

### Operation

An e-mail app running on a cell phone or PC is composed of a free format text input screen. If a user wants to find a list of bread in the area defined by the zip code 90034. Using the text input screen, a user types “bread” and “90034”. If the user wants to search with more detail information such as the price or the price range of the bread then the user types “$1” and “$5” to set the lowest price and the highest price respectively.

Then the user clicks a send button of the e-mail app, which sends the information to the mail server and data servers.

Then the searched result, containing the list of the bread in stores in the 90034 ZIP code area and its price range from $1 to $5, is sent back to the e-mail app as a message.

### Advantages

From the description above, a number of advantages of this search method using the e-mail app become evident:

(a) Advantage of using this invention provides a simple search method to find the lowest priced product or services in any given area without the use of the Internet.

(b) Shoppers can search exact information out of large numbers of daily or weekly sales items (without scrolling many pages) using any devices that have the capability to send and receive e-mails.

(c) Yet, another advantage is this method can save advertising cost for stores' owners because they do not need to print and send daily or weekly sales flyers to homes and to place daily or weekly sales information on their web sites.

These ideas above mentioned are just few good and beneficial to consumers who are thinking of using any cell phones to search daily and weekly sales items in today's mobile life style, and business owners who want to save their advertising cost.

### CONCLUSION, RAMIFICATIONS, AND SCOPE

Accordingly, the reader will see following additional advantages using this search method in that:
it provides accurate search results of any products and services for shoppers;
it provides direct connection between shoppers and stores;
it reduces the number of flyers printed weekly, which is good for the environment;
it reduces electricity usage since users do not need to use a computer; and
it works for all cell phone devices since e-mail software runs independent of all cell phone communication infrastructure globally.

Although the description above contains many specifications, these should not be construed as limiting the scope of the invention but as merely providing a description of how to use this invention.

Further, the scope of the invention should be determined by the appended claims and their legal equivalents, rather than by the example given.

I claim:

1. E-mail addresses comprising of a plurality of local-parts of search e-mail addresses having a plurality of search descriptive words connected by a plurality of a same distinctive character, @ signs, and domain names.
(a). Wherein said same distinctive character is comprised of any one of these characters, which are the following: !, #, $, %, &, ', *, +, −, /, =, ?, ̂, _, `, {, |, }, ˜, at least.
(b). Wherein said search descriptive words are comprised of a plurality of product names, descriptions, prices, and other related information, which are stored in said data servers.
(c). Wherein said domain name means that they are comprised of a plurality of mail servers having means of receiving said search e-mail addresses and a plurality of data servers having said product information at least.

2. A process of creating and registering a plurality of search e-mail addresses containing a plurality of search descriptive words when said search e-mail addresses are not found in a plurality of mail servers,

3. E-mail application software comprising of a function to input a plurality of search descriptive words, a function to connect a plurality of same distinctive character to a plurality of search descriptive words to compose a plurality of the local part of search e-mail and a plurality of domain part of addresses, and a method to make communication between a plurality of said e-mail application software and a plurality of e-mail servers at least.
